(19) United States
(12) Patent Application Publication
(10) Pub. No.: US 2011/0038322 A1
(43) Pub. Date: Feb. 17, 2011

(54) METHOD AND DEVICE TO SUPPORT INTERWORKING BETWEEN 3G SYSTEM SAE SYSTEM

(75) Inventor: Huarui Liang, Bejing (CN)

Correspondence Address: Jefferson IP Law, LLP, 1130 Connecticut Ave., NW, Suite 420, Washington, DC, 20036, US

(73) Assignee: SAMSUNG ELECTRONICS CO., LTD., Suwon-city, Gyeonggi-do (KR)

(21) Appl. No.: 12/989,848

(22) PCT Filed: Apr. 29, 2009
(86) PCT No.: PCT/KR2009/002235

§ 371 Date: Oct. 27, 2010

(30) Foreign Application Priority Data
May 2, 2008 (CN) 200810094988.7

(51) Int. Cl. H04W 4/00

(52) U.S. Cl. 370/328

(57) ABSTRACT

The present invention provides a method and device to support interworking between 3G system and SAE system, and the method includes steps of detecting by PDN-GW if any NON-GBR packet data protocol context exists in all packet data protocol contexts corresponding to a terminal or not; triggering by PDN-GW a packet data protocol context establishment process to ensure that the NON-GBR packet data protocol context is always well established in the network, if there is no NON-GBR packet data protocol context. With the method of the present invention, an LTE terminal accessing through the 3G network can still enjoy services provided by a default bearer after it moves from the 3G network to the SAE network.

### TECHNICAL FIELD

The present invention relates to mobile communication, and in particular to a method and device to support interworking between a 3G system and an SAE system.

### BACKGROUND ART

A conventional SAE system architecture is illustrated in FIG. 1. Description of the SAE system architecture in FIG. 1 is given below. FIG. 1 also shows a system architecture for interworking between a 3G system and a System Architecture Evolved (SAE) system.

User Equipment (UE) 101 is a terminal device to receive data. It can operate in either the 3G system or the LTE system. EUTRAN (Evolved UMTS Terrestrial Radio Access Network) 102, also called ENB, is a wireless access network in the evolved system SAE, and is for providing an interface through which an LTE mobile phone can access the wireless network. And through an interface S1, ENB 102 connects to the mobile phone's mobility management entity (MME) 103 and a user plane entity Serving Gateway 104. MME 103 is for managing UE's mobile context, conversation context, and storing user information on security. Serving Gateway 104 primarily provides a function of user plane. An interface S1-MME provides UE with establishment of wireless access bearer, and forwards messages sent from UE to MME over the wireless access network. The combined function of MME 103 and Serving Gateway 104 is similar to that of an original SGSN (general packet radio service (GPRS) supporting node) 108.

Both MME and Serving Gateway can be provided in one same physical entity. PDN Gateway 105 is for functions like accounting, legal monitoring, etc. Both the Serving Gateway and the PDN Gateway can be provided in one same physical entity. UTRAN 107 is a wireless access network for UE under a 3G system. SGSN 108 is a device providing routing for data transmission in the existing UMTS. The conventional SGSN finds corresponding Gateway GPRS Supporting Nodes (GGSN) according to Access Point Name (APN). HSS 109 is the UE's home subscription sub-system. It is for storing user information including UE's current location, the serving node's address, user security related information, UE's activated packet data protocol (PDP) context and so on. PCRF 106 provides QoS policy and accounting criteria through interface S7.

In general, a terminal accesses the SAE system through E-UTRAN 102. During the access process, MME initiates a default bearer establishment. After the terminal completes its access process, an activated default bearer always exists in the SAE network. In the SAE system, the type of the default bearer is NON-GBR (NON Guarantee Bit Rate). Depending on service type, bearers can be divided into two types: one is GBP (guarantee bit rate) bearers, and the other is the NON-GBR bearers. NON-GBR bearers correspond to interactive or background category. GBR bearers correspond to streaming or conversational category.

### DISCLOSURE OF INVENTION

### Technical Problem

A terminal, however, accesses a 3G system initially through UTRAN 107, i.e., it accesses an outside network through SGSN 108, serving gateway 104 and PDN-GW 105. During the attach procedure, the core network will not establish any default bearer for the terminal. Or, after the attach procedure is completed, only GBR packet data protocol context exists in the 3G network due to service requirement. As a result, a problem needs to be settled about how to establish a default bearer for a terminal when it moves into an LTE network, so as to guarantee that the terminal in SAE can enjoy services provided via the default bearer.

### Technical Solution

An object of the present invention is to provide a method to support interworking between a 3G system and a SAE system, with which method, SAE network can establish a default bearer for a terminal after it moves into the SAE system, and the terminal can enjoy services provided by the default bearer.

To achieve the above object, according to an aspect of the present invention, a method to support interworking between a first system and a second system, comprising steps of:

detecting, by a node for managing a packet data protocol context for a UE in the first system, whether any NON Guarantee Bit Rate (NON-GBR) packet data protocol context exists in all packet data protocol contexts or not;

If not, initiating by the node a context establishment process to establish a packet data protocol context of NON-GBR type, and storing by the UE the NON-GBR packet data protocol context; and

establishing a default bearer by the UE using the NON-GBR packet data protocol context, after the UE moves into the second system.

According to another aspect of the present invention, a node for managing UE's packet data protocol context, comprising:

a detection module adapted to detect whether any packet data protocol context of NON-GBR type exists in all managed packet data protocol contexts or not;

a context establishment module adapted to, if no NON-GBR packet data protocol context exists, initiate a context establishment process to establish a NON-GBR packet data protocol context, so that the UE can store the packet data protocol context; and

a bearer establishment module adapted to establish a default bearer by using the NON-GBR packet data protocol context.

With the method of the present invention, a LTE terminal accessing through the 3G network can still enjoy services provided by a default bearer after it moves from the 3G network to the SAE network.

### BRIEF DESCRIPTION OF DRAWINGS

FIG. 1 shows a network architecture of SAE system;

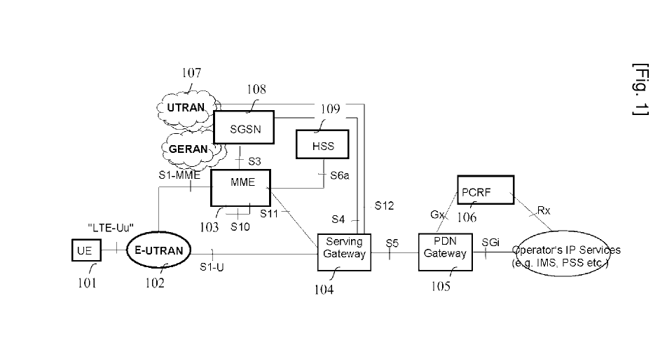

FIG. 2 is a schematic diagram showing a second context activation process initiated by PDN-GW according to an embodiment of the present invention;

FIG. 3 is a schematic diagram showing a packet data protocol data context activation process initiated by UE according to another embodiment of the present invention;

FIG. 4 is a schematic diagram showing a second context activation process initiated by PDN-GW according to another embodiment of the present invention;

FIG. 5 shows a process of establishing default bearers;

FIG. 6 shows a block diagram of the structure of a network node according to the present invention;

FIG. 7 is a schematic diagram showing a packet data protocol context activation process initiated by PDN-GW according to another embodiment of the present invention;

FIG. 8 shows a second context activation process; and

FIG. 9 shows a conventional packet data protocol context activation process.

### MODE FOR THE INVENTION

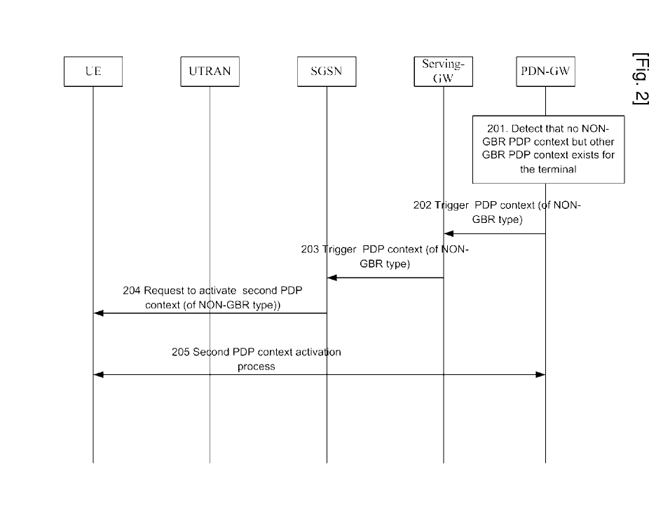

FIG. 2 shows a flow of a second context activation process triggered by PDN-GW to guarantee the default bearer established in the first system according to an embodiment of the present invention. The detailed description is given below, and detailed description of the content well known will be omitted in the following.

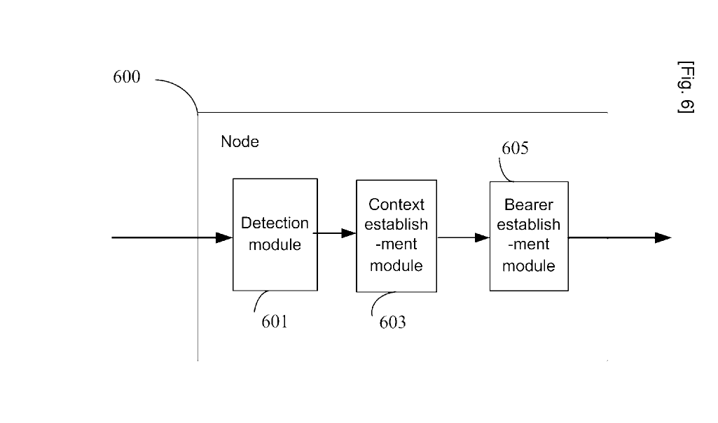

The default bearer establishment procedure is implemented by the node of the present invention, as shown in FIG. 6. The node 600 is a node in a 3G system and for managing a packet data protocol context of UE. The node 600 comprises a detection module 601 for detecting whether there is any NON-GBR packet data protocol context in all of the managed packet data protocol contexts, a context establishment module 603 and a bearer establishment module 605. As can be appreciated by one skilled in the art, the node 600 can be, but not limited to a terminal or PDN-GW.

Now, the network-requested second context activation process will be explained with reference to FIGS. 2 and 6.

201 If any activated packet data protocol context exists in the network, the detection module 601 in PDN-GW detects whether any NON-GBR packet data protocol context exists in the packet data protocol context corresponding to the terminal, and whether the rest of the activated packet data protocol context is of GBR type. If there is no NON-GBR packet data protocol context, PDN-GW triggers a second packet data protocol context request process.

202 According to the detection result, PDN-GW triggers a secondary packet data protocol context request procedure. Through the context establishment module 603, PDN-GW requests that the packet data protocol context is of NON-GBR type. The type of the packet data protocol context is specified as NON-GBR in the request message sent from PDN-GW to the serving gateway.

203 The request message sent from the serving gateway to SGSN carries the type parameter of the packet data protocol context obtained from PDN-GW.

204 SGSN sends out a secondary packet data protocol context request message, which carries the type parameter of the packet data protocol context obtained from the serving gateway.

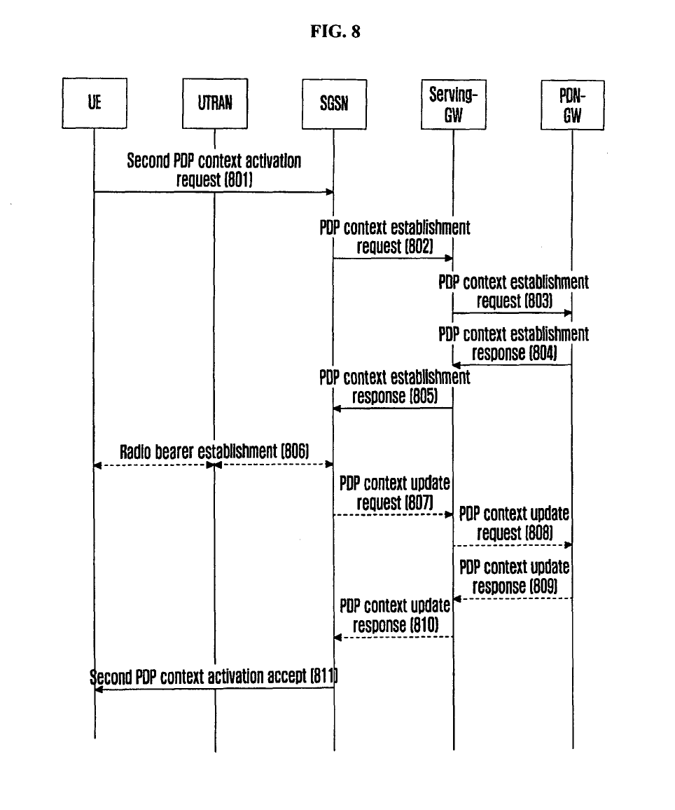

205 The secondary context activation procedure is performed in the same way as the conventional one, as shown in FIG. 8.

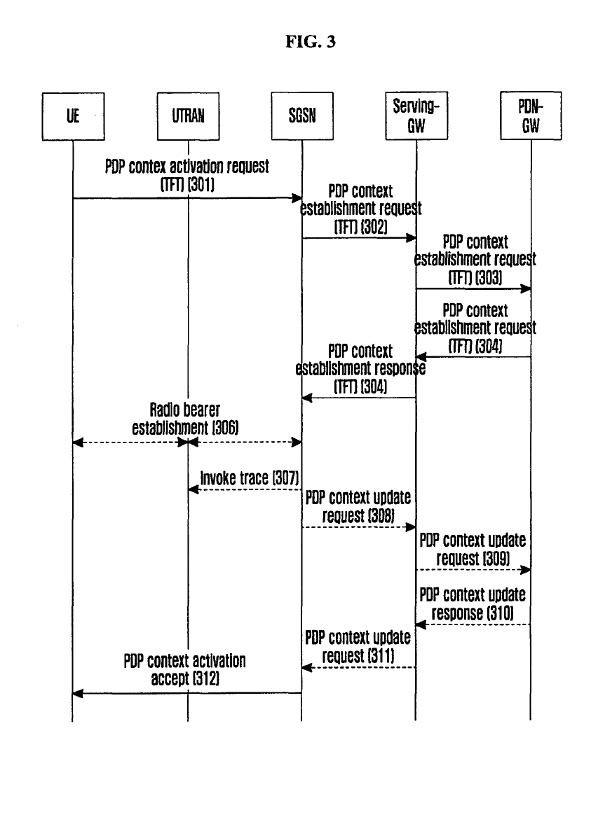

Embodiment 2 of the present invention describes the packet data protocol context activation process initiated by UE, as shown in FIG. 3. The detailed description is given below, and detailed description of the content well known will be omitted in the following. The node in FIG. 6 can be used to implement the packet data protocol context activation process in Embodiment 2.

Embodiment 2 is an alternative solution of Embodiment 1, and they both can be applied in a scenario where PDN-GW detects no presence of NON-GBR packet data protocol context but any other type of activated packet data protocol context.

301 Before initiating the packet data protocol context activation request, the terminal determines the type of the packet data protocol context. If the packet data protocol context is of NON-GBR type, the terminal implements the conventional packet data protocol context activation process. On the other hand, if the packet data protocol context is of GBR type, the terminal allocates a traffic flow template (TFT) to the packet data protocol context and carries the TFT in a packet data protocol context activation request message.

302 SGSN sends a request message for packet data protocol context establishment to the serving gateway, and the request message carries the parameter TFT obtained by SGSN from the terminal.

303 The serving gateway sends the request message for packet data protocol context establishment to PDN-GW, and the request message carries the parameter TFT.

304 PDN-GW sends a packet data protocol context establishment response to the serving gateway.

305 The serving gateway sends the packet data protocol context establishment response to SGSN.

306 The process of establishing a radio bearer is performed.

307 A trace message is invoked.

308 SGSN sends a packet date protocol context update request to the serving gateway.

309 The serving gateway sends the packet date protocol context update request to PDN-GW.

310 PDN-GW sends a packet date protocol context update response to the serving gateway.

311 The serving gateway sends the packet date protocol context update response to SGSN.

312 SGSN sends a packet date protocol context activation accept message to UE.

As can be seen from the above, the process of 304-312 is identical to the packet date protocol context activation process in the existing SAE system.

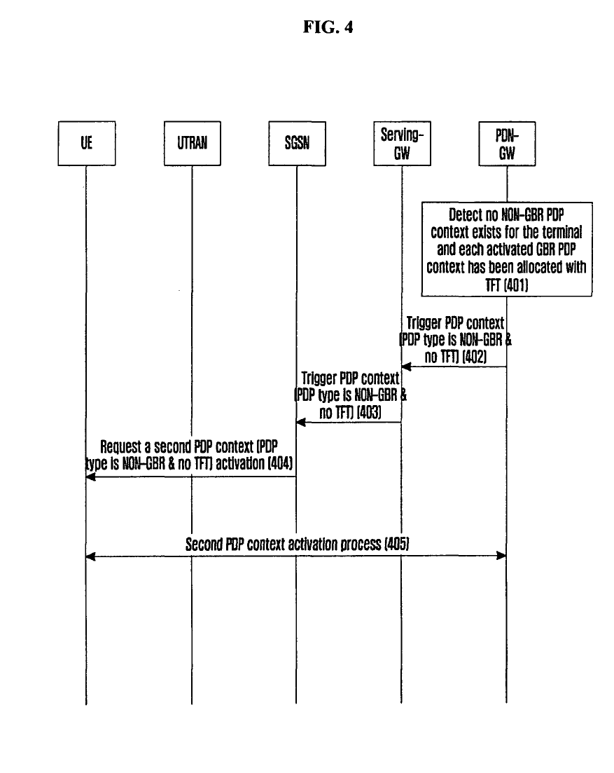

FIG. 4 illustrates a secondary packet date protocol context activation process triggered by PDN-GW according to a further embodiment of the present invention. The following is detailed description to this figure.

401 PDN-GW detects whether the terminal has any NON-GBR packet data protocol context, and whether there is any other activated GBR packet data protocol context allocated with TFT. If PND-GW detects that the terminal does not have any NON-GBR packet data protocol context, and there is some other GBR packet data protocol context allocated with TFT, PND-GW triggers a secondary context activation procedure to activate the NON-GBR packet data protocol context, and PDN-GW does not allocate any TFT for this packet data protocol context.

402 PDN-GW sends a trigger context message to the serving gateway, determines that the packet data protocol context is NON-GBR, and allocates no TFT to this packet data protocol context.

403 The serving gateway sends the trigger context message to SGSN, and the message carries the type of the packet data protocol context (NON-GBR) obtained from PDN-GW.

404 SGSN sends a second context activation request message to UE, and the request message carries the type of the packet data protocol context obtained.

405 The second packet data protocol context activation process is performed in the same way as the conventional one, as shown in FIG. 8.

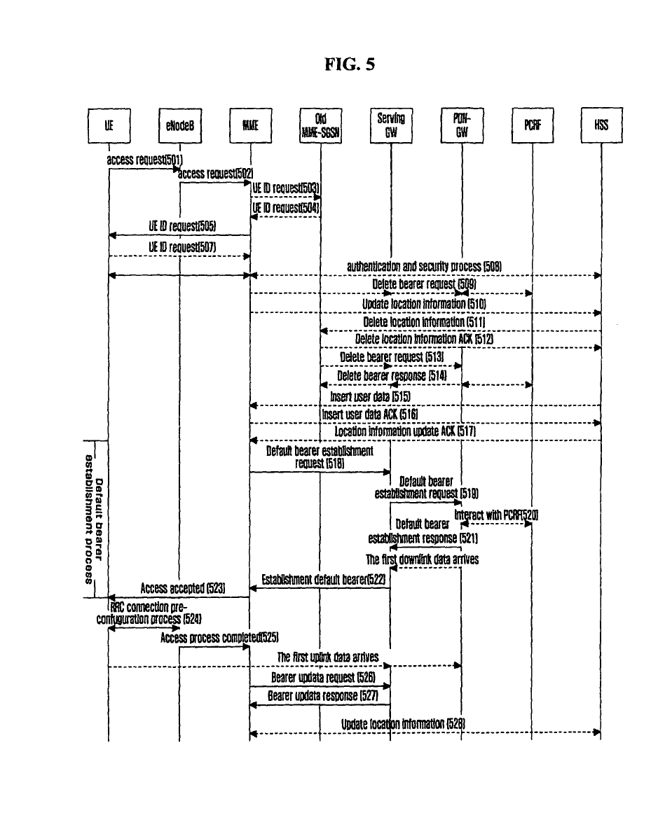

FIG. 5 describes an attach procedure initiated by UE in a scenario where an LTE terminal accesses the network through E-UTRAN. This process comprises a procedure of establishing a default bearer, in which 517 ? 522 indicate a process initiated by MME to establish a default bearer. And this process must be completed during the attach procedure. Only when the default bearer establishment process is completed successfully, the attach procedure can succeed. The bearer establishment module 605 in FIG. 6 is for establishing a default bearer.

501 UE sends an attach request to ENB.

502 ENB sends the attach request to MME.

503 If MME does not have UE's IMSI, MME sends a UE ID request to an old MME/SGSN to request for UE's IMSI.

504 The old MME/SGSN sends a response to the ID request to the newly accessed MME, and the response carries the IMSI.

505 UE can not be identified by either new or old MME. For example, if UE attaches to MME for the first time, MME sends a UE ID request message to UE.

507 UE reports its IMSI in a UE ID response message.

508 The network needs to implement authentication and integrity protection process for UE.

509 If MME has this activated bearer information for UE, e.g., if this UE attaches MME once again, but detach is not correctly implemented before the re-attach, MME sends a delete bearer request message to the serving gateway and PDN-GW. During this procedure, interaction with PCRF is possible in order to obtain or update information on policy and accounting.

510 If the currently accessed MME is not the same one as MME from which UE is detached, or if the current MME has no valid UE subscription context information, or if ID of MME changes, MME sends an update location information message to HSS.

511 HSS sends a delete location information message to the old MME.

512 The old MME deletes information on the mobility management and bearer context of UE.

513 The old MME sends a delete bearer request message to the serving gateway and then to P-GW, to delete information on the original bearer of UE in the serving gateway and P-GW.

514 Each of P-GW and the serving gateway send a delete bearer ACK message to MME. If necessary, relevant information will be interacted between P-GW and PCRF.

515 HSS sends an insert user data information message to the new MME.

516 MME sends an insert user data information ACK message to HSS.

517 HSS sends an update location information ACK message to MME.

518 MME selects a proper serving gateway and PDN-GW according to PDN-GW selection principle and serving gateway selection principle. Then, MME sends a default bearer establishment request message to the selected serving gateway, and the message includes QoS capability required for the default bearer.

519 The serving sends the default bearer establishment request message to PDN-GW, and the message includes QoS capability required for the default bearer.

520 If the network supports dynamic policy and accounting information control, PDN-GW possibly receives new policy information sent from PCRF.

521 After the default bearer is established successfully, PDN-GW sends a default bearer establishment response message to the serving gateway.

522 The serving gateway sends the default bearer establishment response message to MME. Now, the serving gateway is capable of receiving downlink data.

523 If the UE is permitted to attach the network, MME sends an attach accept message to the UE.

524 RRC connection and configuration process is implemented between UE and ENB.

525 ENB sends an attach completed message to MME. Now, the network can receive uplink data from UE.

526 MME sends a bearer update request message to the serving gateway according to new information on bearer context.

527 According to the obtained parameter, the serving gateway updates the bearer information on UE and sends a bearer update response message to MME.

528 MME sends a location information update message to HSS. And HSS sends an ACK message to MME after it updates the location information.

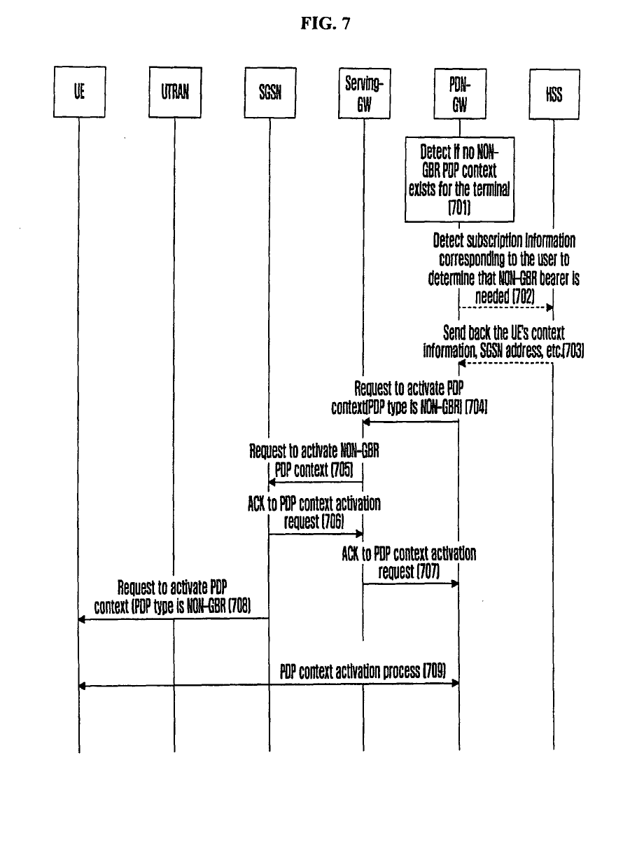

FIG. 7 illustrates a packet data protocol context activation process triggered by PDN-GW according to a further embodiment of the present invention.

701 PDN-GW detects whether the terminal has any NON-GBR packet data protocol context. If not, PDN-GW triggers a packet data protocol context activation process.

702 By sending a detection message to HSS, PDN-GW can determine UE's subscription information and confirm that the UE needs an NON-GBR default bearer.

703 According to the ID information of UE, HSS searches for information, such as context information and SGSN address, corresponding to the UE. And the information parameter is sent back via an ACK message.

704 PDN-GW requests to initiate a packet data protocol context activation process for this UE terminal, and specifies the type of the packet data protocol context as NON-GBR. PDN-GW sends a packet data protocol context activation request message to the serving gateway.

705 After receiving the request message, the serving gateway sends the packet data protocol context activation request message to SGSN, with the type of the packet data protocol context carried in the request message being NON-GBR.

706 After receiving the request message, SGSN sends an ACK message to the serving gateway, informing that SGSN will send a packet data protocol context activation request message to UE.

707 The serving gateway sends an ACK message to PDN-GW, informing PDN-GW that SGSN will send a packet data protocol context activation request message to UE.

708 SGSN sends a packet data protocol context activation request message to UE, with the type of the packet data protocol context being carried in the message.

709 UE initiates a packet data protocol context activation process, which is identical to that defined in the existing standard.

FIG. 8 describes the secondary context activation process.

801 The terminal initiates a second packet data protocol context activation message, which includes information on data flow template TFT, requested QoS, etc.

802 SGSN sends a packet data protocol context establishment request message to the serving gateway, and the request message includes such parameters as TFT, QoS and the like obtained from the terminal by SGSN.

803 The serving gateway sends the packet data protocol context establishment request message to PDN-GW, and the request message includes such parameters as TFT, QoS and the like.

804 PDN-GW sends a packet data protocol context establishment response message to the serving gateway, and the request message carries information on tunnel ID, etc., allocated by PDN-GW to the newly established packet data protocol context.

805 The serving gateway sends the packet data protocol context establishment response message to SGSN, and the message carries information on tunnel ID, etc., allocated by the serving gateway to the newly established packet data protocol context.

806 The process of establishing a radio bearer is performed.

807 SGSN sends a packet data protocol context update request message to the serving gateway.

808 The serving gateway sends the packet data protocol context update request message to PDN-GW.

809 PDN-GW sends a packet data protocol context update response message to the serving gateway.

810 The serving gateway sends the packet data protocol context update response message to SGSN.

811 SGSN sends a second packet data protocol context activation accept message to UE.

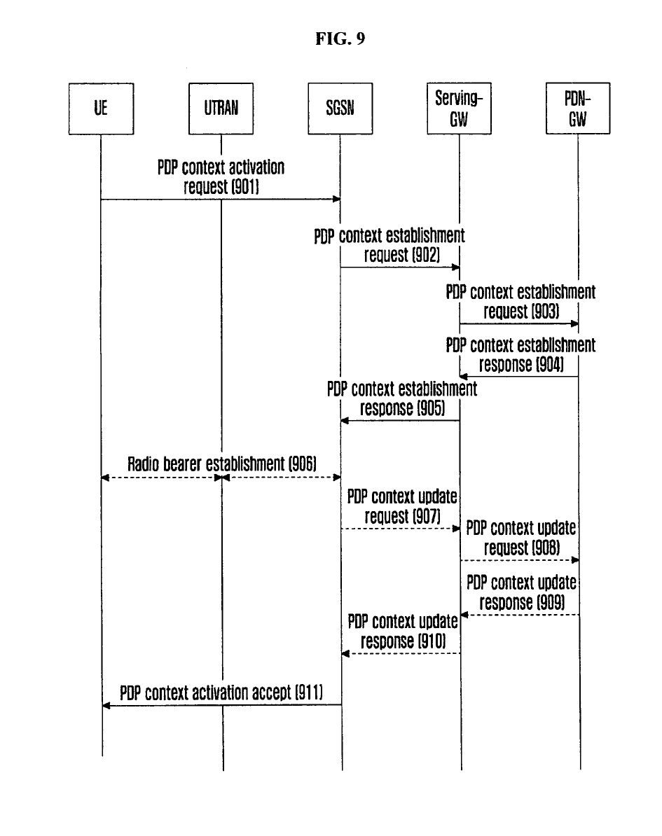

FIG. 9 illustrates the conventional packet data protocol context activation process.

901 The terminal initiates a packet data protocol context activation message, and the message includes information on access point name APN, required QoS, the type of the packet data protocol context, etc.

902 SGSN sends a packet data protocol context establishment request message to the serving gateway, and the request message carries parameters like the access point name APN, QoS, the type of the packet data protocol context, etc., obtained by SGSN.

903 The serving gateway sends the packet data protocol context establishment request message to PDN-GW, and the request message carries parameters like the access point name APN, QoS, the type of the packet data protocol context, etc.

904 PDN-GW sends a packet data protocol context establishment response message to the serving gateway, and the message carries information on tunnel ID, etc. allocated by PDN-GW to the newly established packet data protocol context.

905 The serving gateway sends the packet data protocol context establishment response message to SGSN, and the message carries information on tunnel ID, etc., allocated by the serving gateway to the newly established packet data protocol context.

906 The process of establishing a radio bearer is performed.

907 SGSN sends a packet data protocol context update request message to the serving gateway.

908 The serving gateway sends the packet data protocol context update request message to PDN-GW.

909 PDN-GW sends a packet data protocol context update response message to the serving gateway.

910 The serving gateway sends the packet data protocol context update response message to SGSN.

911 SGSN sends a second packet data protocol context activation accept message to UE.

Although the present invention is described with reference to the above embodiments, all these embodiments are intended for illustrating rather than limiting the present invention. Those skilled in the art can readily make modification, additional or deletion to these embodiments without departing from the spirit and scope of the present invention.

1. A method to support interworking between a first system and a second system, comprising steps of:
detecting, by a node for managing a packet data protocol context for a UE in the first system, whether any Packet Data Protocol (PDP) with default bearer QoS exists in all packet data protocol contexts or not;[Huarui1]
if not, initiating by the node a context establishment process to establish a packet data protocol context for PDP with default bearer QoS profile, and storing by the UE the PDP with default bearer QoS; and
the PDP with default bearer QoS is utilized for establishing default bearer after the UE moves into the second system.

2. The method of claim 1, wherein, if no packet data protocol context with default bearer QoS profile exists for the UE, the packet data protocol context establishment procedure includes a packet data protocol context activation procedure.

3. The method of claim 1, wherein, if some packet data protocol context of any other type exists for the UE, the packet data protocol context establishment process includes a secondary packet data protocol context activation process.

4. A node for managing a packet data protocol context for a UE, comprising:
a detection module adapted to detect whether any packet data protocol context with default bearer QoS profile exists in all managed packet data protocol contexts or not;
a context establishment module adapted to, if no PDP context with default bearer QoS profile exists, initiate a context establishment procedure to establish a PDP context with default bearer QoS profile, so that the UE can store the packet data protocol context; and
a bearer establishment module adapted to establish a default bearer by using PDP context with default bearer QoS profile.

5. The method of claim 1, wherein, after UE moves into the second system, the PDP context with default bearer QoS is transferring to the second system, and is utilized for mapping into default bearer context and for default bearer establishment.
